(19) United States
(12) Patent Application Publication
(10) Pub. No.: US 2007/0201932 A1
(43) Pub. Date: Aug. 30, 2007

(54) DIGIT-OPERATED INPUT DEVICE

(76) Inventor: Michael Rong, Hsinchu (TW)

Correspondence Address: PAI PATENT & TRADEMARK LAW FIRM, 1001 FOURTH AVENUE, SUITE 3200, SEATTLE, WA, 98154, US

(21) Appl. No.: 11/457,148

(22) Filed: Jul. 13, 2006

(30) Foreign Application Priority Data
Feb. 13, 2006 (TW) 95104755

(51) Int. Cl. B41J 5/00

(52) U.S. Cl. 400/489

(57) ABSTRACT

A digit-operated input device used for entering data into an electronic device includes: a dragging line, a digit locator, a press sensor, and a control unit. One end of the dragging line is connected to a user's digit while the other end is connected to the digit locator, which outputs a position signal when the position of the digit is detected through the dragging of the dragging line. The press sensor detects a pressing motion of the digit and then outputs a press signal. The control unit is connected to the digit locator and the press sensor to integrate the positional signal and the press signal and to output the same to the electronic device.

### BACKGROUND OF THE INVENTION

a) Field of the Invention

The invention relates to an input device and, more particularly, to a digit-operated input device.

b) Description of the Related Art

Hand-operated keyboards and pointing devices like computer mice and joysticks are the most common input devices that use a user's digits as the input tool. Being hefty and taking up a relatively large space are common complaints about these input devices, which fail to meet the light-weight, thin, short, and compact qualities most users desire.

A keyboard of a desktop computer is bound to take up a specific amount of space because of the proper key size and spacing thereon, and thus the space being occupied cannot be effectively reduced. On the other hand, the keyboard arrangement of a notebook computer is non-ergonomic, hard for someone with adult hand size to use, and leads to fatigue, even may cause injuries, with long term use of such keyboard. In spite of this, along with the enhancement of computation speed and storage space in personal digital assistants and mobile telephones, the need for users to input data to these electronic devices increases. However, besides the fact that it is difficult to dispose standard keyboards on these compact electronic devices, these one-size-fits-all keyboards are not suitable to all users because of the differences in hand sizes among people.

An approach of replacing the physical keyboard with a virtual keyboard was proposed to solve the aforementioned problems users have encountered with physical keyboards. One method is to optically project a keyboard on a surface and then trace finger movements with a 3D image sensor to determine the data entered by the user. The disadvantage of this method is that it consumes more computation resource and power, which in turn shortens the operation time of portable electronic devices. Another method is to dispose an acceleration sensor at a digit tip to continually trace movements in the x-y direction and pressing motions of the finger, but then the measured acceleration has to be integrated twice for orientation, which also consumes more computation resource and power of portable electronic devices. In addition, the complex computation causes a longer response time, inconveniencing real-time input by the user. Furthermore, there are also input devices that trace the changes in finger joints with data gloves worn by a user to determine where the user has entered. This kind of input device did not gain widespread popularity because it has complicated structure and the user has to change their original input behavior and learn a new input method.

Users often use a pointing device in combination with a keyboard when entering data into an electronic device. For example, when filling out a form on a web page, most users would first use the mouse to select a column and then use the keyboard to enter information; the alternation between using the mouse and keyboard means frequent switching of input devices, which lowers the data input efficiency.

Summing up the above, there is a need for a digit-operated input device that is lightweight, compact, and suitable for all users without having to change their input habit, and that further combines functions of a pointing device with a keyboard and operates with a shorter response time and lower power consumption while maintaining simple computation.

### BRIEF SUMMARY OF THE INVENTION

In view of the aforementioned problems, it is an object of the invention to provide a digit-operated input device that is space-efficient, lightweight, and ergonomic.

Another object of the invention is to provide a digit-operated input device that incorporates functions of a pointing device and operates with a shorter response time and lower power consumption while maintaining simple computation.

To achieve the aforementioned objects, a digit-operated input device of the invention for entering data into an electronic device includes: a dragging line, a digit locator, a press sensor, and a control unit. One end of the dragging line is physically connected to a digit of a user while the other end of the dragging line is connected to the digit locator that detects the digit position through the dragging of the dragging line and outputs a position signal. The press sensor detects a pressing motion of the digit and outputs a press signal. The control unit is signal-connected to the digit locator and the press sensor to integrate the position signal and the press signal, and outputs the integrated signals to the electronic device.

In the digit-operated input device according to the invention, the position where the user's digit pressed is located to determine the data being entered, and so all sorts of virtual input devices like keyboards and pointing devices can be emulated. Since the virtual input device is not physical and can be of any size, the input device of the invention effectively utilizes space and is suitable for users with different hand sizes to use. In addition, because the input device of the invention locates the digit position with simple coordinates but without complex computation, hence, the input device can be operated with relatively lower power consumption while maintaining a shorter response time.

### BRIEF DESCRIPTION OF THE DRAWINGS

FIG. 1 is a schematic diagram illustrating the infrastructure of a digit-operated input device according to an embodiment of the invention.

FIG. 2 is a schematic diagram illustrating a partial structure of a digit-operated input device according to an embodiment of the invention.

FIG. 3 is a schematic diagram illustrating a method to locate digit positions in the invention.

FIG. 4A and FIG. 4B are schematic diagrams illustrating two layouts of typing keys.

FIG. 5 is a schematic diagram illustrating a virtual piano keyboard provided by the invention.

### DETAILED DESCRIPTION OF THE INVENTION

The digit-operated input device according to preferred embodiments of the invention will be described below with reference to the drawings, in which like reference numerals denote like elements.

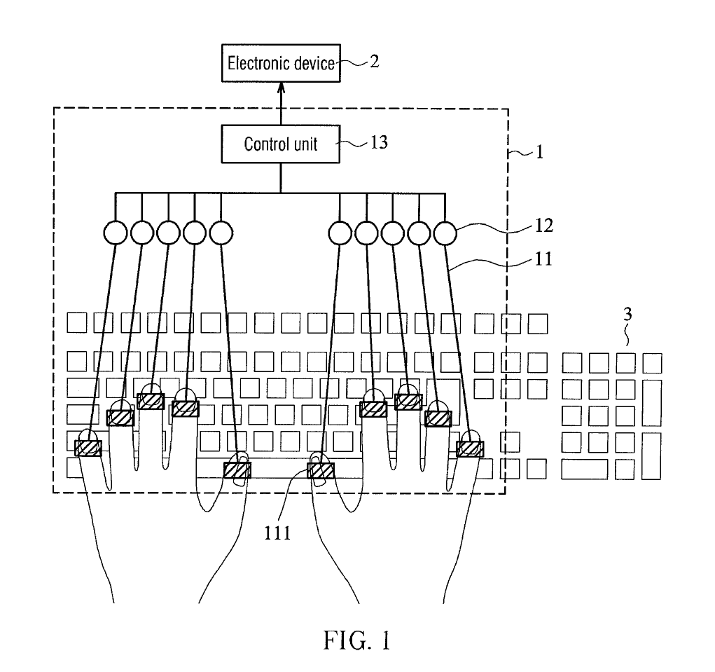

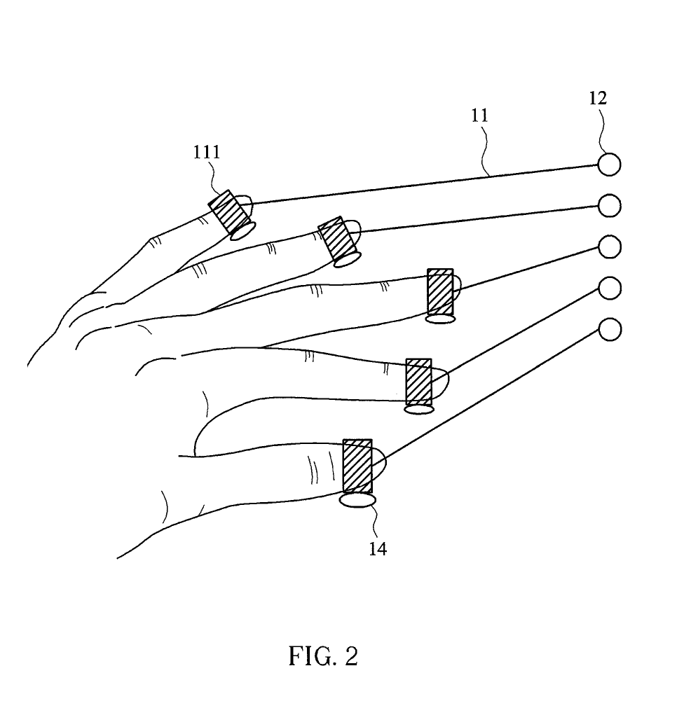

A digit-operated input device 1 according to a preferred embodiment of the invention as shown in FIGS. 1 and 2 is described using an example of entering data by a user's fingers. The digit-operated input device 1 for entering data to an electronic device 2 includes: a dragging line 11, a digit locator 12, a press sensor 14, and a control unit 13. One end of the dragging line 11 is physically connected to the user's finger while the other end is physically connected to the digit locator 12 which outputs a position signal after detecting the position of the user's finger through the dragging of the dragging line 11. The press sensor 14 detects a pressing motion of the user's finger and outputs a press signal. The control unit 13 is connected to the digit locator 12 and the press sensor 14 via signals, and it integrates the position signal and the press signal and outputs the integrated signal to the electronic device 2. Based on the position signal and the press signal, the electronic device 2 can identify the data entered by the user. For example, on a virtual keyboard 3 provided by the control unit 13, if the user's finger performs a pressing motion while it is at the position of the virtual “J” key, the electronic device 2 would know that the user has input the letter “J”.

The press sensor 14 shown in FIG. 2 is a pressure sensor and is disposed at a pressing face of the finger in such a way that when the user performs a pressing motion, the press sensor would acknowledge the occurrence of the pressing motion due to the pressure change created thereby. The press signal can be wire or wirelessly transmitted to the control unit 13. In cases where the press signal is to be wire transmitted to the control unit 13, the dragging line 11 can serve as a signal transmission line without having to dispose an additional signal transmission line for transmitting the press signal. And in cases where the press signal is to be wirelessly transmitted, a wireless communication module is disposed to connect to the press sensor 14 via signals so as to wirelessly transmit the press signal to the control unit 13.

It is to be noted that the location where the press sensor 14 is provided as shown in FIG. 2 is exemplary and is not limited thereto. In other embodiments, the press sensor 14 may be an acceleration sensor disposed at one end of the dragging line to detect an acceleration change of the user's finger to determine whether the user has executed a pressing motion. The acceleration sensor is preferably to be disposed at the end of the dragging line 11 other than the end to which the digit locator 12 is connected.

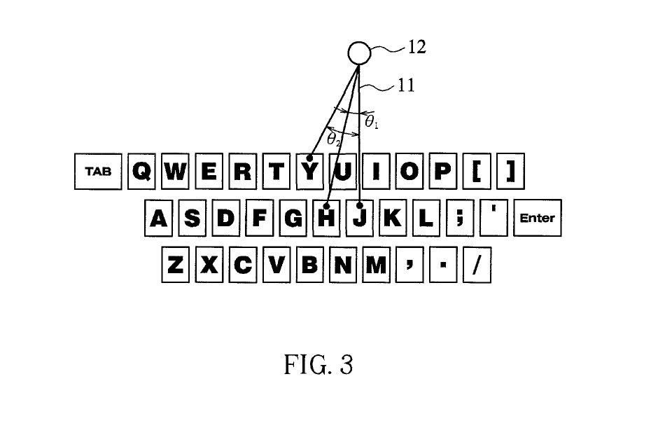

The digit locator 12 includes a base and a driven component that is physically connected to the dragging line 11 and assembled to the base. When the driven component moves along to the displacement of the user's finger, a coordinate generator disposed in the base detects the amount of movement made by the driven component and generates the position signal; the positioning technique used herein is similar to the orientation principle used in pointing devices like mouse, trackball, joystick, etc. FIG. 3 illustrates how the digit locator 12 determines the position of the user's finger. Take inputting text by a keyboard as an example, when the right index finger moves from its resting position, the virtual “J” key, to the position of the virtual “H” key, the dragging line 11 drags the driven component in the digit locator 12 to rotate an angle of Θ₁ and thus a change in the x-coordinate occurs. When the index finger moves to the position of the virtual “Y” key, the driven component rotates an angle of Θ₂ and thereby a change in the x-coordinate and the y-coordinate occurs. Hence, when an included angle between the dragging line 11 and its projection on a digit-pressed plane is greater than 0°, the position of the user's finger can be located based on a change in x and y coordinates; the included angle between the dragging line 11 and the projection is 0° when the dragging line substantially lay on the digit-pressed plane, wherein the digit-pressed plane is where a digit performed a pressing motion onto.

When there are multiple key candidates for the position that the finger can move to in the same direction, the digit locator 12 may further include a distance sensor for detecting the displacement of the user's finger to uniquely locate the position of the finger based on direction and distance.

It is to be noted that the base and the driven component of the digit locator 12 can be assembled with and disassembled from one another whenever necessary. Also, the input device 1 of the invention can be a built-in component of the electronic device 2 or can be a portable individual independent of or partly dependent on other devices. For example, the base can be disposed directly on the electronic device 2, and a user simply carries with them the driven component and assembles it to the base when the user wants to enter data into the electronic device 2. Moreover, the base can also be provided on a support and signal-connected to the electronic device 2 through a communication interface on the support, for sending the entered data to the electronic device 2. The communication interface can be an USB interface, a PS/2 interface, or a wireless transmission interface.

The input device 1 further includes a line winder connected to one end of the dragging line 11 for giving a tension force to the dragging line 11. Due to the tension force in the dragging line 11, motions of the user's finger can be conveyed to the digit locator 12, and from the length of the dragging line 11 being wound, distance displaced by the finger can be observed. The input device 1 further includes a tension controller connected to the line winder. The tension controller controls the line winder to keep the tension force of the dragging line 11 within a set-value range, whereby motions of the user's finger are conveyed to the digit locator 12 without compressing the finger. For example, although the distances between the digit locator 12 and the virtual keys, respectively “Y” and “N”, are different, the tension controller can control the line winder so that the right index finger feels a same or similar tension force in the dragging line 11 when positioned on the virtual “Y” key and “N” key. Moreover, the tension controller can loosen the tension force in the dragging line 11 in idle state and tightens the tension force therein in working state.

Referring to FIG. 2, the input device 1 further includes a digit accessory 111 connected to the end of the dragging line 11 to which the finger is connected, and by wearing the digit accessory 111, the user's finger is physically connected to the dragging line 11. In one embodiment, the digit accessory 111 and the dragging line 11 are electromagnetically connected. When in idle state, the control unit 13 can cut off electric power to remove the magnetic force between the digit accessory 111 and the dragging line 11 so as to disconnect the two, allowing the user's hands to freely move and perform other work besides data entry. And when in working state, the control unit 13 turns on electric power to restore the magnetic force between the digit accessory 111 and the dragging line 11 so as to reconnect the two, allowing the user to continue entering data into the electronic device 2.

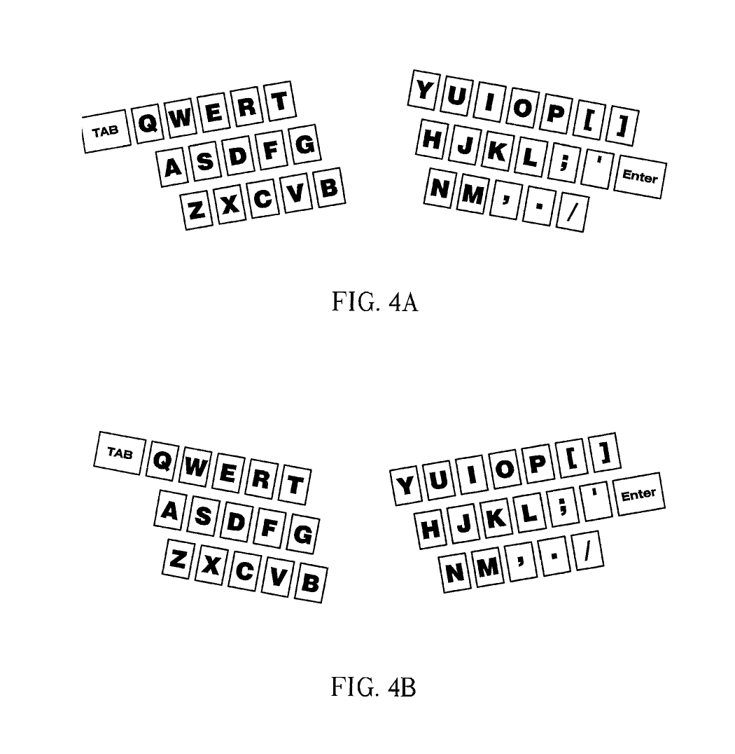

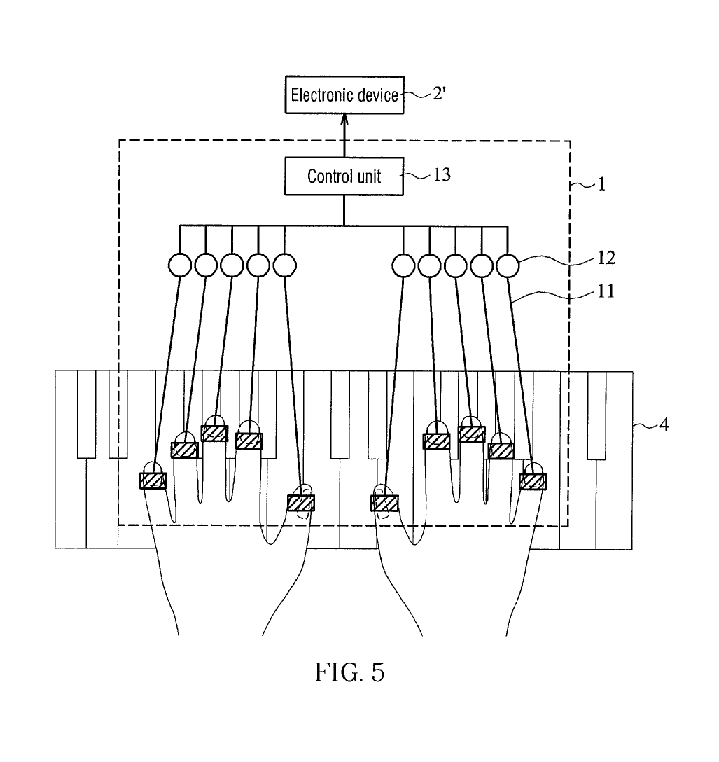

Since the input device 1 of the invention does not contain physical keys, all keys are virtual and provided by the control unit 13, which also arranges the positions of the virtual keys. Take a typing keyboard as an example, aside from being in a standard keyboard layout, the keys can be arranged and positioned as shown in FIG. 4A or 4B for conforming to ergonomics. The user can even change the size and spacing of the keys to customize the virtual keyboard for individual hand size; the desirable keyboard setting can be set by the user through software to adjust each parameter of the control unit 13, and thus a virtual keyboard that caters to individual work habits and needs of the user can be easily obtained at any time. Moreover, the input device 1 of the invention provides virtual keyboards that can be used for entering data into electronic devices like computers, personal digital assistants, or mobile telephones and for inputting data to electronic instruments. As shown in FIG. 5, the electronic device 2′ is an electronic instrument such as an electronic piano, and the control unit 113 provides virtual piano keys 4 on which the user can play directly. In this embodiment, the press signal can be an analog signal to reflect the magnitude of the pressing force. Hence, the control unit 13 can be a programmable integrated circuit, whereby through proper set up, it can provide all types of virtual keys, like typing keys and piano keys.

As aforementioned, the digit locator 12 generates coordinate information similar to what a pointing device does, and so the input device 1 of the invention can be used directly as a pointing device. In addition, the input device 1 of the invention may include a plurality of digit locators 12, whereby a plurality of virtual pointing devices are provided to respectively control a plurality of objects in the electronic device. In cases where the input device 1 of the invention has both keyboard and pointing device functions, the user can assign a predetermined action to switch the input device 1 to the keyboard mode or the pointing device mode. For example, the predetermined action can be three consecutive clicks by little finger or moving a digit towards certain direction, and upon which the user switches over from the keyboard to the pointing device and vice versa.

It is to be noted that in the invention, the “digit” used to enter data refers not only to the user's finger but also to the user's toe. Although the technical content of the invention thus far has been described by using the user's finger to perform an input action, the input action can also be performed by the user's toe with proper setting of the keys.

The digit-operated input device of the invention determines what data the user has input by locating where the user's digit presses, and therefore the digit-operated input device can provide all sorts of virtual input devices like typing keyboard, piano keyboard, and so on once the user has defined, in advance, what data each press position represents. Since a virtual input device, like the virtual keyboard, is not physical and can be of any size and arrangement, the input device of the invention effectively utilizes space to create an input device that is ergonomic for any hand size. The input device of the invention can also simulate the function of a pointing device by locating the digit position. In addition, the input device of the invention uses simple coordinates, not complex computation, to locate the digit position; thus the input device of the invention operates with relatively lower power consumption and maintains a shorter response time.

While the invention has been described by way of example and in terms of the preferred embodiments, it is to be understood that the invention is not limited to the disclosed embodiments. In other words, it is intended to include equivalent modifications and changes of the above embodiments without departing from the spirit and scope of the invention as would be apparent to those skilled in the art. Therefore, the scope of the appended claims should be accorded the broadest interpretation so as to encompass all such equivalent modifications and changes.

What is claimed is:

1. A digit-operated input device for entering data into an electronic device, comprising:
a dragging line physically connected to a digit of a user at one end;
a digit locator physically connected to the other end of the dragging line, for outputting a position signal after detecting the position of the digit through the dragging of the dragging line;
a press sensor for outputting a press signal after detecting a pressing motion of the digit; and
a control unit connected to the digit locator and the press sensor via signals, for integrating the position signal and the press signal and outputting an integrated signal to the electronic device.

2. The digit-operated input device as described in claim 1, wherein the press sensor is a pressure sensor and is provided at a pressing face of the digit to detect the pressing motion of the digit.

3. The digit-operated input device as described in claim 2, wherein the dragging line is a signal transmission line for the press signal.

4. The digit-operated input device as described in claim 2, further comprising:
a wireless radio communication module connected to the press sensor via signals, for wirelessly transmitting the press signal to the control unit.

5. The digit-operated input device as described in claim 1, wherein the press sensor is an acceleration sensor and is provided at one end of the dragging line to detect an acceleration change of the digit and to determine whether the user has executed the pressing motion.

6. The digit-operated input device as described in claim 5, wherein the acceleration sensor is provided at the end of the dragging line other than the end to which the digit locator is connected.

7. The digit-operated input device as described in claim 1, wherein the digit locator comprises:
a base with a coordinate generator provided therein; and
a driven component physically connected to the dragging line and capable of being freely assembled with and disassembled from the base, wherein the driven component moves along to a displacement of the digit and the coordinate generator generates the position signal by detecting the amount of movement made by the driven component.

8. The digit-operated input device as described in claim 7, wherein the digit locator further comprises a distance sensor for detecting the displacement of the digit, and the distance sensor in conjunction with the coordinate generator locates the position of the digit to generate the position signal.

9. The digit-operated input device as described in claim 7, wherein the base is provided in the electronic device.

10. The digit-operated input device as described in claim 7, further comprising:
a support, in which the base is provided, the support having a communication interface to connect to the electronic device via signals.

11. The digit-operated input device as described in claim 1, further comprising:
a line winder connected to one end of the dragging line, for giving a tension to the dragging line to convey the movement of the digit to the digit locator.

12. The digit-operated input device as described in claim 11, further comprising:
a tension controller connected to the line winder, for controlling the line winder to keep the tension of the dragging line within a set-value range.

13. The digit-operated input device as described in claim 12, wherein the tension controller loosens the tension of the dragging line in idle state and tightens the tension of the dragging line to the set-value range in working state.

14. The digit-operated input device as described in claim 1, further comprising:
a digit accessory connected to the end of the dragging line to which the digit is connected, wherein the digit is physically connected to the dragging line by wearing the digit accessory thereon.

15. The digit-operated input device as described in claim 14, wherein the digit accessory is electromagnetically connected to the dragging line; when in idle state, the control unit cuts off electric power to remove the magnetic force to disconnect the digit accessory and the dragging line, and when in working state, the control unit turns on electric power to restore the magnetic force to reconnect the digit accessory and the dragging line.

16. The digit-operated input device as described in claim 1, wherein the electronic device is a computer, a personal digital assistant, a mobile telephone, or an electronic musical instrument.

17. The digit-operated input device as described in claim 1, which provides a virtual keyboard and the user can set the position, size, and spacing of keys on the keyboard.

18. The digit-operated input device as described in claim 1, which provides a virtual pointing device, wherein multiple digits of the user correspondingly represent multiple pointing devices to respectively control multiple objects in the electronic device.

19. The digit-operated input device as described in claim 1, which provides a virtual keyboard and a virtual pointing device, wherein by a predetermined action of the digit, the user can switch over from using the keyboard to the pointing device and vice versa.

20. The digit-operated input device as described in claim 1, wherein an included angle greater than 0° is between the dragging line and its projection on a digit-pressed plane.

21. The digit-operated input device as described in claim 1, wherein the control unit is a programmable integrated circuit.
